(19) United States
(12) Patent Application Publication
(10) Pub. No.: US 2022/0325824 A1
(43) Pub. Date: Oct. 13, 2022

(54) Hinge Nut for Meter Coupling Valve

(71) Applicant: Meter Technology Werks, LLC, Tampa, FL (US)

(72) Inventors: Matthew White, Tampa, FL (US); Eric Allard, Plant City, FL (US); Martin Cole, Ocala, FL (US); Kyle Vest, Waverly, NE (US); Nate Rasmussen, Lincoln, NE (US)

(21) Appl. No.: 17/575,697

(22) Filed: Jan. 14, 2022

Related U.S. Application Data
(60) Provisional application No. 63/174,481, filed on Apr. 13, 2021.

(51) Int. Cl. F16K 51/00; F16K 5/08; F16K 1/20

(52) U.S. Cl. CPC F16K 51/00; F16K 5/08; F16K 1/2042

(57) ABSTRACT

Embodiments of the present invention provide a hinge nut apparatus for a meter coupling. In an embodiment of the invention, the hinge nut includes at least two portions attached to each other by a hinge pin adjacent a distal end of each portion and the two portions are configured to be moved between an open position and a closed position. The closed position forms an outer surface and an opening forming an inner surface. The inner surface includes a first interior diameter adjacent a distal end of the opening and a second interior diameter adjacent the first interior diameter. The second interior diameter is greater than the first interior diameter and forms a lip and at least a portion of the second interior diameter includes threading.

### CROSS-REFERENCE TO RELATED APPLICATION

This application claims priority to U.S. Provisional Patent Application No. 63/174,481 filed on Apr. 13, 2021, the entirety of which is incorporated herein by reference.

### BACKGROUND OF THE INVENTION

### Field of the Invention

The present invention relates to the field of valves in couplings for meters and more particularly to valves in couplings for water meters and gas meters.

### Description of the Related Art

Meters for fluids, such as water meters and gas meters, are utilized to determine the volume of fluid being supplied to a residential or commercial structure. The meter is assembled between the water lines or gas lines of the structure and the utility lines of the utility company supplying the water or gas. The meter then measures and records the volume of fluid flowing through the meter. The volume of the fluid is then read off of the meter either visually or remotely for processing.

Typically, a manual shut off valve is connected to the meter so that the provider or the party receiving the supply of water of gas can shut off the supply for any reason, such as stopping service or repairs. The manual shut off valve often requires a specialized tool or key to manually open or close the shut off valve. Further, the manual shut off valve often becomes covered in dirt due to its location in the ground and must be dug up to locate and operate. As the shut off valve must be manually operated, either the provider must send someone or the party receiving the service must be present to operate the shut off valve. Thus, problems may not be addressed in a timely fashion leading to water damage or unintended service interruptions. As well, there are additional problems in affixing new shut off valves (or other valves) to meters that are already installed in the ground.

### BRIEF SUMMARY OF THE INVENTION

Embodiments of the present invention address deficiencies of the art in respect to valves in meter couplings and provide a novel and non-obvious apparatus for a hinge nut for a meter coupling. In an embodiment of the invention, the hinge nut includes at least two portions attached to each other by a hinge pin adjacent a distal end of each portion and the two portions are configured to be moved between an open position and a closed position. In the closed position, the hinge nut forms an outer surface and an opening forming an inner surface. The inner surface includes a first interior diameter adjacent a distal end of the opening and a second interior diameter adjacent the first interior diameter. The second interior diameter is greater than the first interior diameter and forms a lip and at least a portion of the second interior diameter includes threading.

In one aspect of the embodiment, the closed position of the hinge nut is secured by a fastener towards a distal end opposite the hinge pin. In another aspect of the embodiment, the fastener engages a nut where the nut is press fit into a hole located between the inner surface and outer surface of the hinge nut. In another aspect of the embodiment, the fastener engages a nut where the nut is molded into a hole located between the inner surface and outer surface of the hinge nut. In another aspect of the embodiment, the outer surface is polygonal in cross-section. In yet another aspect of the embodiment, the outer surface is hexagonal in cross-section. In even yet another aspect of the embodiment, the inner surface is cylindrical in cross-section.

In another embodiment of the invention, an apparatus includes a meter coupling attached to an end of a meter with a hinge nut. The end of the meter includes threading on its outer surface. The meter coupling includes an inlet at a distal end of the meter coupling, an outlet at a distal end opposite the inlet, where one of the distal ends forming a lip and other of the distal ends includes threading on an outer surface, and a housing between the inlet and the outlet where the housing includes a valve. The hinge nut is attached to the one of the distal ends forming the lip. The hinge nut includes at least two portions attached to each other by a hinge pin adjacent a distal end of each portion and the two portions are configured to be moved between an open position and a closed position. The closed position forms an outer surface and an opening forming an inner surface. The inner surface includes a first interior diameter adjacent a distal end of the opening and a second interior diameter adjacent the first interior diameter. The second interior diameter is greater than the first interior diameter and forms a lip and the lip of the hinge nut configured to retain the lip of the meter coupling. At least a portion of the second interior diameter includes threading and the threading of the hinge nut is configured to engage with the threading of the meter.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is an isometric assembled view of a pictorial illustration of a battery-powered valve in a meter coupling in accordance with an embodiment of this invention;

FIG. 2 an isometric exploded view of a pictorial illustration of a battery-powered valve in a meter coupling in accordance with an embodiment of this invention;

FIG. 3 is a left isometric exploded view of a pictorial illustration of a hinge nut of a battery-powered valve in a meter coupling in accordance with an embodiment of this invention; and

FIG. 4 a right isometric exploded view of a pictorial illustration of a hinge nut of a battery-powered valve in a meter coupling in accordance with an embodiment of this invention.

### DETAILED DESCRIPTION OF THE INVENTION

Embodiments of the invention provide for an apparatus for a battery-powered valve in a meter coupling. In an embodiment of the invention, a battery-powered valve, such as a shut-off valve, in a meter coupling may be coupled to either end (the inlet or outlet) of an existing meter. The meter coupling also includes an inlet and outlet, where one side is connected to the meter and the other side is connected to the existing plumbing. The meter includes components for measuring the volume of fluid, such as water or gas, flowing through the meter.

The battery-powered valve may be contained within a housing of the meter coupling. The meter coupling may include a motor controller, such as an actuator controller, that controls the valve, along with an internal transceiver or receiver to receive instructions to control the valve or the valve may be in communication with an external transceiver or receiver. Thus, an external transceiver or transmitter may transmit instructions to the motor controller to open or close or partially open/close the valve. The valve may be powered by batteries, such as rechargeable or replaceable batteries that are contained within the meter coupling. In operation, the meter includes an inlet that attaches to the supply of fluid and an outlet that attaches to the fluid lines of the residential or commercial structure. The meter coupling that includes the battery-powered valve may be attached to the inlet or outlet of the meter. The transceiver of the valve receives instructions to open, close or partially open/close the valve to either allow, stop or restrict fluid flow. The valve then automatically opens, closes or partially opens/closes to provide sustenance flow to the occupant in response to the instructions. The valve may also be cycled intermittently to keep it from sticking so that it will continue to work.

The meter coupling may be coupled to the meter by a hinge nut so that the meter coupling can be easily retrofitted to existing meters. The hinge nut includes two halves or portions that are attached to each other at one end by a hinge pin. At an opposite end from the hinge pin, a fastener secures the ends of the hinge nut together. The fastener may be separate or built into the hinge nut. Thus, hinge nut can be easily moved from an open position to a closed position around an inlet or outlet of an existing meter to couple a meter coupling to the inlet or outlet of the existing meter and subsequently secured with the fastener. In order to couple the hinge nut to the inlet or outlet of the meter, threading of the hinge nut mates with corresponding threading on the outer portion of the inlet or outlet of the meter. Further, a retaining lip of the hinge nut engages a corresponding lip of the meter coupling on the inlet or outlet of the meter coupling. The meter coupling may also include a slip nut to tighten the end of the meter coupling lip against the hinge nut retaining lip to seal the meter coupling inlet or outlet, hinge nut, and meter inlet or outlet.

In operation, the inlet or outlet end of the meter coupling that includes the lip is placed facing the inlet or the outlet end of the meter. The hinge nut halves are moved from an open position to a closed position around both the meter coupling end and the meter end. The hinge nut halves are then secured to each other with the fastener. The lip of the meter coupling is retained on the interior of the hinge nut by the retaining lip of the hinge nut halves and the threading of the meter engages with the corresponding threading of the hinge nut halves. A gasket or seal or washer may be placed between the threading of the meter and the meter coupling. The slip nut of the meter coupling is then tightened so that the end of the meter coupling lip is tightened against the hinge nut retaining lip. In this way, the meter coupling is able to be attached to an existing meter that would otherwise need to be removed in order to rotate the meter coupling along the threading of the meter.

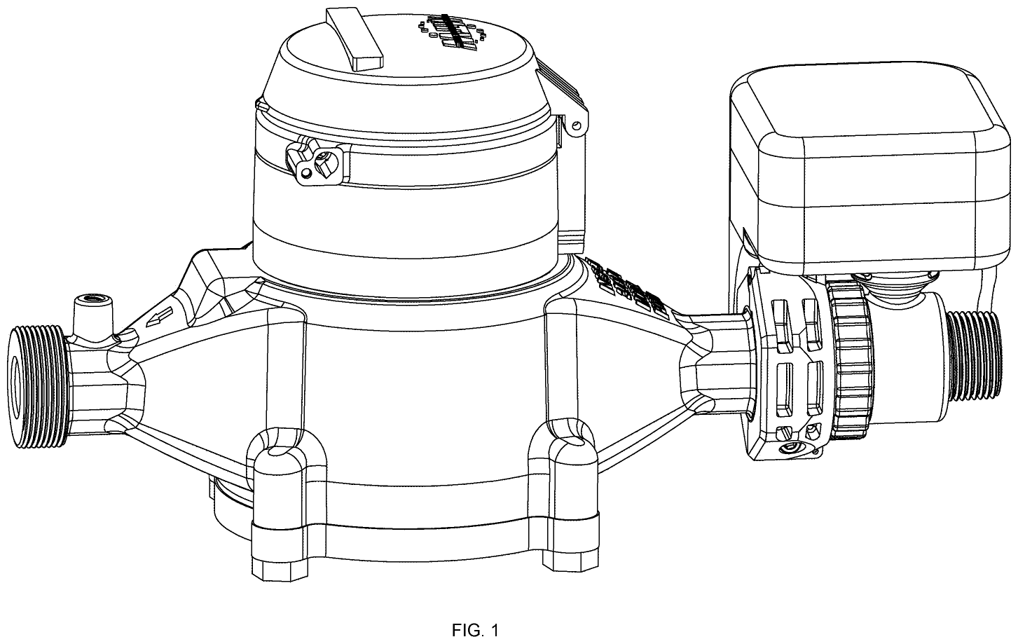

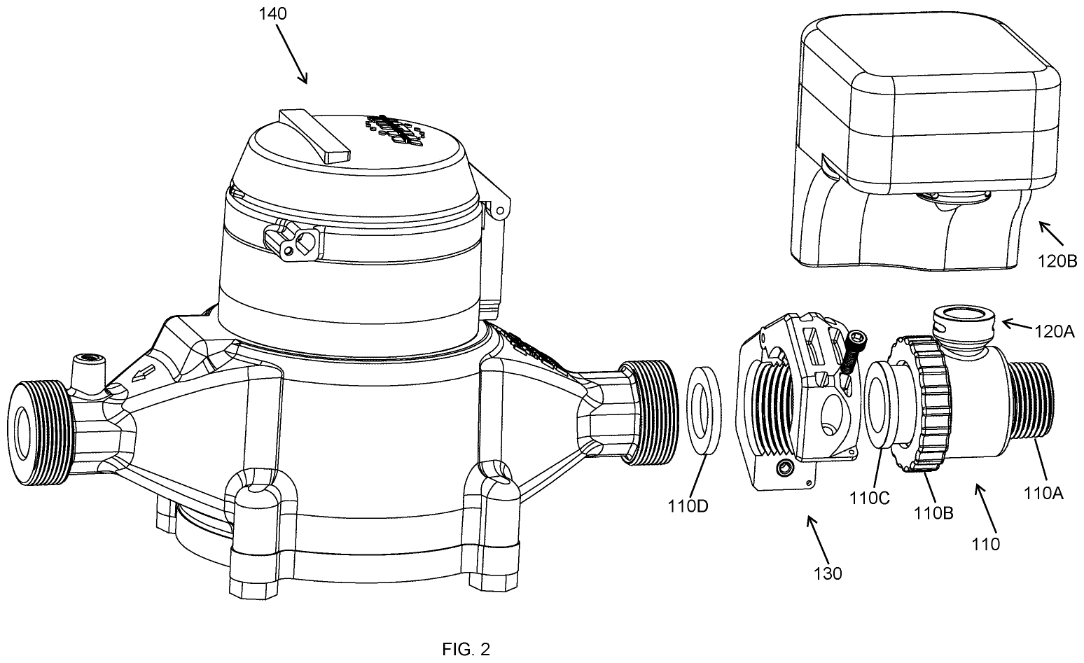

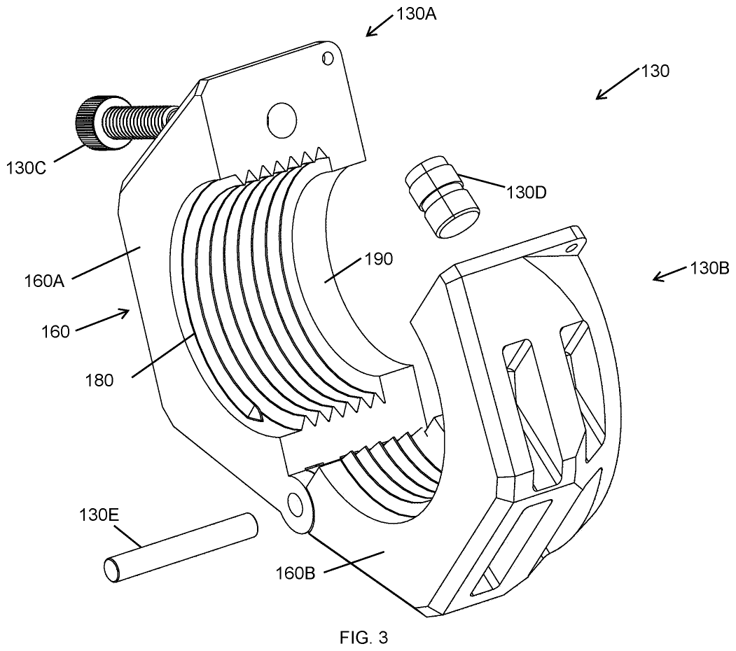

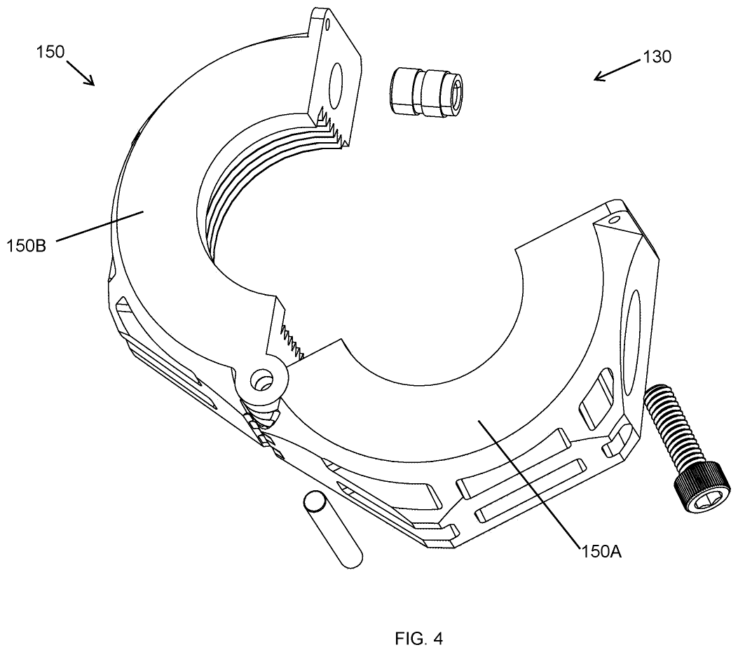

In further illustration, FIGS. 1 and 2 pictorially show a battery-powered meter coupling valve and FIGS. 3 and 4 pictorially show a hinge nut of a battery-powered meter coupling valve in accordance with embodiments of this invention. The tailpiece or meter coupling 110 includes a battery-powered valve in the housings 120A, 120B that is on the meter tailpiece. The housings 120A, 120B may house the valve with an internal battery and electronic device, such as a motor controller and transceiver, to operate the valve. The housings may be any size, shape or configuration.

The meter coupling 110 may be coupled to either end of meter 140 with hinge nut 130. The threading 110A on the end of the meter coupling 110 allows the meter coupling to connect to either the supply lines from the utility company supplying the water or gas or the supply lines between the meter and the structure or dwelling. Similarly, the threading on the ends of the inlet or outlet of the meter 140 allows the meter 140 to connect to supply lines from the utility company supplying the water or gas or the supply lines between the meter and the structure or dwelling. As slip nut 110B is rotated, the face of the slip nut moves closer to and may push against face of the hinge nut thereby tightening and securing the lip 110C of the meter coupling against a corresponding retaining lip 190 of the hinge nut. The hinge nut 130 is threaded on to the meter threads until tightening and securing the lip 110C of the meter coupling against a corresponding retaining lip 190 of the hinge nut.

The meter coupling 110 may be secured to the meter with hinge nut, which is made up of the hinge nut components: hinge nut half 130A, hinge nut half 130B hinge nut fastener 130C, hinge nut fastener nut 130D, and hinge pin 130E. The hinge nut halves 130A, 130B may be permanently attached by the hinge pin 130E or the hinge pin may be removable. The hinge nut includes a face 150 facing the meter coupling and an opposite face 160 facing the meter. As can be seen, the hinge nut 130 is made up of two halves 130A and 130B that are attached to each other to form the hinge nut. Thus, face 150 is made up faces 150A, 150B of the respective half and face 160 is made up faces 160A, 160B of the respective half.

On the exterior of the hinge nut 130, hinge nut fastener 130C and hinge nut fastener nut 130D secures the hinge nut halves 130A, 130B to each other. The hinge nut halves 130A, 130B may include grooves or channels or holes on the exterior sized and shaped for the corresponding hinge nut fastener 130C and hinge nut fastener nut 130D. The hinge nut fastener nut 130D and/or the hinge nut fastener 130C may be molded into the hole on the respective hinge nut half. In this way, the respective hinge nut half would include a molded-in threaded insert and the opposite hinge nut half would include corresponding female threading, so the two can be bolted together. Alternatively, the hinge nut fastener nut 130D may be press fit into the hole on the exterior of the hinge nut (in between the inner and outer surface of the closed hinge nut) when it is secured to the hinge nut fastener 130C to secure the hinge nut halves 130A, 130B together. An outer surface of the hinge nut is formed when the hinge nut halves are moved to a closed position. The figures depict the surface as substantially hexagonal in cross-section, however, any polygonal or cylindrical cross-section is within the scope of this invention.

The opening in the hinge nut 130 forms an interior or inner surface of the hinge nut that is cylindrical in cross-section when in the closed position. The inner surface of the hinge nut includes a include a retaining lip 190 formed by the respective halves on one end of the opening. While the retaining lip is shown as cylindrical in cross-section, the retaining lip being polygonal in cross-section is within the scope of this invention. Further, the hinge nut halves include threading 180 formed by the respective halves adjacent the retaining lip towards the opposite end of the opening. The retaining lip is located towards the end adjacent face 150 facing the meter coupling and the threading is located towards the end adjacent face 160 facing the meter. As can be seen, the interior diameter of the portion of the inner surface of the hinge nut with the threading is greater than the interior diameter of the portion of the inner surface of the hinge nut with the retaining lip, which thereby forms the retaining lip. The retaining lip is configured to engage or retain lip 110C of the meter coupling with a gasket or seal or washer 110D in between and the threading is configured to engage the corresponding threading on the inlet or outlet of the meter 140.

As depicted in FIGS. 1 and 2, the meter coupling 110 may include housing 120A, 120B. Housing 120A, 120B may include a valve, a motor controller configured to open and close the valve, a transceiver in communication with the motor controller and configured to receive instructions to open and close the valve, and batteries in communication with the motor controller and transceiver configured to power the motor controller and receiver. Thus, when a transmitter or transceiver transmits instructions to the receiver or transceiver of the meter coupling 110, the valve may automatically open or close. If the meter coupling also includes a transmitter, so that the receiver and transmitter are a transceiver, the transmitter may send a status of the valve or a status of the batteries to the corresponding external transceiver. The valve in housing 120A can also be manually operated with a manual handle (not shown) when housing 120B is removed.

The battery-powered valve, the meter coupling, the hinge nut components, and the meter, may be manufactured from materials including, but not limited to, bronze, cast iron, stainless steel, plastics or other non-corrosive materials, or any combination of the materials. The meter may be cast into place or assembled separately. The meter coupling, including the housing for the battery-powered valve and electronic components, may be cast into place or assembled separately and coupled to the meter with the hinge nut.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A hinge nut apparatus for a meter coupling, the hinge nut comprising:
at least two portions attached to each other by a hinge pin adjacent a distal end of each portion, the two portions configured to be moved between an open position and a closed position, the closed position forming:
an outer surface;
an opening forming an inner surface, the inner surface comprising:
a first interior diameter adjacent a distal end of the opening,
a second interior diameter adjacent the first interior diameter,
the second interior diameter being greater than the first interior diameter forming a lip, and
at least a portion of the second interior diameter comprising threading.

2. The hinge nut apparatus of claim 1, wherein the closed position of the hinge nut is secured by a fastener towards a distal end opposite the hinge pin.

3. The hinge nut apparatus of claim 2, wherein the fastener engages a nut and the nut is press fit into a hole located between the inner surface and outer surface of the hinge nut.

4. The hinge nut apparatus of claim 2, wherein the fastener engages a nut and the nut is molded into a hole located between the inner surface and outer surface of the hinge nut.

5. The hinge nut apparatus of claim 1, wherein the outer surface is polygonal in cross-section.

6. The hinge nut apparatus of claim 1, wherein the outer surface is hexagonal in cross-section.

7. The hinge nut apparatus of claim 1, wherein the inner surface is cylindrical in cross-section.

8. An apparatus comprising:
a meter coupling attached to an end of a meter with a hinge nut, the end of the meter comprising threading on its outer surface, the meter coupling comprising:
an inlet at a distal end of the meter coupling;
an outlet at a distal end opposite the inlet;
wherein one of the distal ends forming a lip and other of the distal ends comprising threading on an outer surface; and
a housing between the inlet and the outlet, wherein the housing comprises a valve; and,
the hinge nut attached to the one of the distal ends forming the lip, the hinge nut comprising:
at least two portions attached to each other by a hinge pin adjacent a distal end of each portion, the two portions configured to be moved between an open position and a closed position, the closed position forming:
an outer surface;
an opening forming an inner surface, the inner surface comprising:
a first interior diameter adjacent a distal end of the opening,
a second interior diameter adjacent the first interior diameter,
the second interior diameter being greater than the first interior diameter forming a lip, the lip of the hinge nut configured to retain the lip of the meter coupling, and
at least a portion of the second interior diameter comprising threading, the threading of the hinge nut configured to engage with the threading of the meter.

9. The hinge nut apparatus of claim 8, wherein the closed position of the hinge nut is secured by a fastener towards a distal end opposite the hinge pin.

10. The hinge nut apparatus of claim 9, wherein the fastener engages a nut and the nut is press fit into a hole located between the inner surface and outer surface of the hinge nut.

11. The hinge nut apparatus of claim 9, wherein the fastener engages a nut and the nut is molded into a hole located between the inner surface and outer surface of the hinge nut.

12. The hinge nut apparatus of claim 8, wherein the outer surface is polygonal in cross-section.

13. The hinge nut apparatus of claim 8, wherein the outer surface is hexagonal in cross-section.

14. The hinge nut apparatus of claim 8, wherein the inner surface is cylindrical in cross-section.
